(19) United States
(12) Patent Application Publication
(10) Pub. No.: US 2026/0078997 A1
(43) Pub. Date: Mar. 19, 2026

(54) HULL STRUCTURE MONITORING SYSTEM AND MONITORING METHOD

(71) Applicant: NIKON CORPORATION, Tokyo (JP)

(72) Inventor: Takashi MIYAWAKI, Machida-shi (JP)

(73) Assignee: NIKON CORPORATION, Tokyo (JP)

(21) Appl. No.: 19/110,129

(22) PCT Filed: Dec. 25, 2023
(86) PCT No.: PCT/JP2023/046467

§ 371 Date: Mar. 10, 2025

(30) Foreign Application Priority Data
Dec. 26, 2022 (JP) 2022-207822

(51) Int. Cl. G01B 7/28; B63B 79/10; G01P 15/18

(52) U.S. Cl. CPC G01B 7/28; B63B 79/10; G01P 15/18

(57) ABSTRACT

A hull structure monitoring system includes a plurality of sensor devices and a server connected to each other via an inboard network of a ship. Each of the plurality of sensor devices targets some members constituting a hull as an object, measures tilt information at each of a plurality of measurement points in different locations in one of two directions intersecting each other in the object, and outputs sensor data including the tilt information to the server. The server receives sensor data from the plurality of sensor devices and acquires shape information of the object as analysis results by performing analysis processing including predetermined computation processing using the sensor data.

### TECHNICAL FIELD

The present invention relates to a hull structure monitoring system and a monitoring method.

Priority is claimed on Japanese Patent Application No. 2022-207822, filed Dec. 26, 2022, the content of which is incorporated herein by reference.

### BACKGROUND ART

Regarding a technique of measuring local deformation occurring in a hull during navigation due to fluctuation in external water pressure and the like, a technique of integrating results of acceleration measurement twice over time has been attempted. However, since fluctuation in gravity based on hull motion is overwhelmingly dominant, there are significant problems with the accuracy of detecting only the smaller deformation in a hull. Patent Document 1 discloses, for example, a device for measuring local deformation in a hull using infrared rays, in which such inconvenience is improved and only the deformation in a hull can be detected.

However, the device disclosed in Patent Document 1 is not suitable for acquiring overall shape information of a hull or constituent members of a ship during navigation.

### CITATION LIST

### Patent Document

Japanese Utility Model Application, Publication No. H4-130010

### SUMMARY OF INVENTION

### Technical Problem

According to a first aspect of the present invention, there is provided a hull structure monitoring system monitoring a shape of a hull of a ship. The hull structure monitoring system includes a plurality of sensor devices and an analysis device connected to each other via an inboard network of a ship. Each of the plurality of sensor devices targets some members constituting the hull as an object, measures tilt information of the object at each of a plurality of measurement points in different locations in one of two directions intersecting each other in the object, and outputs sensor data including the tilt information to the analysis device. The analysis device receives sensor data from the plurality of sensor devices and acquires shape information of the object as analysis results by performing analysis processing including predetermined computation processing using the sensor data.

In this specification, “shape information” is a concept including all information related to change over time in shape, spatial distribution of the amount of deformation, and the like, as well as the shape of an object.

According to a second aspect of the present invention, there is provided a method for monitoring change in shape of a hull of a ship. The monitoring method includes measuring tilt information of a member constituting a shell of the hull at each of a plurality of measurement points in different locations in one of two directions intersecting each other in the member at a predetermined sampling interval using a plurality of sensors, and acquiring information of change over time in shape of the member by performing predetermined computation processing using tilt information of the member at each of the plurality of measurement points measured at the predetermined sampling interval and corresponding locational information at the plurality of measurement points.

### BRIEF DESCRIPTION OF DRAWINGS

FIG. 1 A view schematically showing an overall constitution of a hull structure monitoring system according to an embodiment.

FIG. 2 A block diagram showing an example of a constitution of a sensor device in FIG. 1.

FIG. 3 A perspective view showing a part of a hull of a bulk carrier targeted to be monitored in a cutaway state.

FIG. 4 An extracted and enlarged view showing one hold part in FIG. 3.

FIG. 5 Part (A) of FIG. 5 is a plan view of the bulk carrier in FIG. 3, and part (B) of FIG. 5 is a left side view (view on a port side) of the bulk carrier in FIG. 3.

FIG. 6 An explanatory view of a method for acquiring a shape of one surface of a measurement target member (inner bottom plate), that is a view showing a measurement target member (inner bottom plate) which is extracted and simplified.

FIG. 7 A view showing a flow of a shape acquiring method.

FIG. 8 Part (A) of FIG. 8 is an explanatory view of a measurement surface on a three-dimensional orthogonal coordinate system (x, y, z), and part (B) of FIG. 8 is an explanatory view the measurement surface on a polar coordinate system (x=ρ cos θ, y=ρ sinθ).

FIG. 9 A flowchart showing a processing algorithm executed by a CPU of a computation processing unit of the sensor device.

FIG. 10 A flowchart showing a processing algorithm defined in a program executed by the CPU of a server.

FIG. 11 A view showing components of a first few terms of a Zernike polynomial in Expression (1) as a shading pattern within a unit circle in a polar coordinate system (ρ, θ).

### DESCRIPTION OF EMBODIMENT

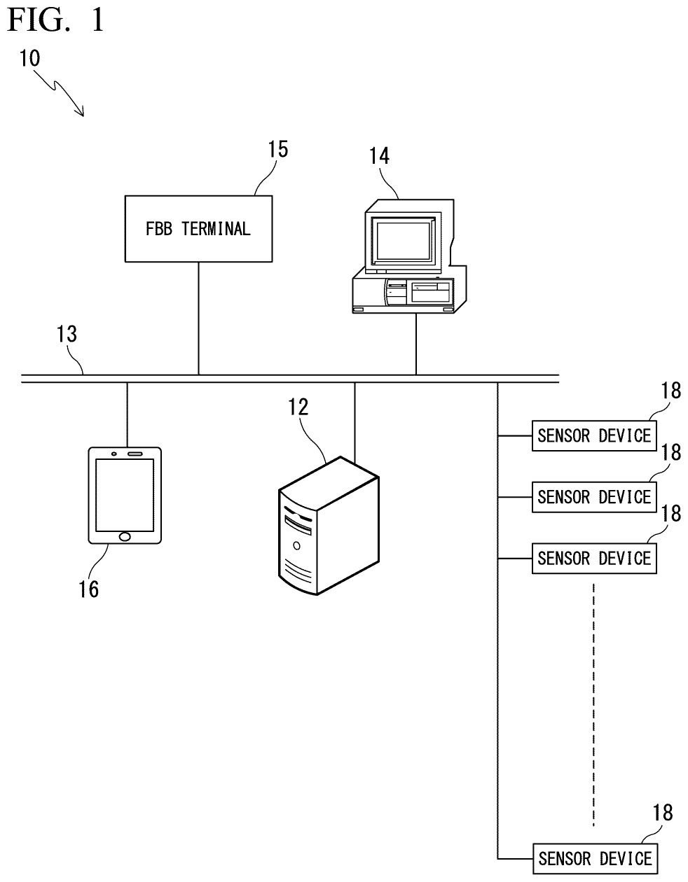

Hereinafter, an embodiment will be described based on FIGS. 1 to 11. Here, as an example, a case in which a monitoring object is a Handymax bulk carrier (which will hereinafter be referred to as a present ship as appropriate) will be described. Here, Handymax indicates a ship which typically has an overall length of 150 to 200 meters and a deadweight tonnage of 52,000 to 58,000 and is equipped with five holds and four cranes.

FIG. 1 schematically shows an overall constitution of a hull structure monitoring system 10 according to the embodiment. A hull indicates a structure main body forming the skeleton and the outline of a ship, excluding a rigging, an engine, and the like. A hull is a collective term for plating structures (shell plates, ribs, and longitudinals), deck structures (decks, beams, and under-deck longitudinals), a bottom structure (a single bottom support plate, inner keels, deck girders, and a double bottom inner bottom plate), a bow structure (bow framing and bracket plates), a stern structure (stern framing and stern support plates), bulkhead structures (bulkhead plates, anti-buckling materials, and transverse beams), and the like, as well as bracket plates, beams, columns, and the like connecting these.

The hull structure monitoring system 10 includes a server 12 also functioning as an analysis device, a bridge-side computer 14, a fleet broadband (FBB) terminal 15, a mobile terminal 16, and a plurality of sensor devices 18, which are connected to each other via an inboard LAN 13. The plurality of sensor devices 18 are connected to the inboard LAN 13 via communication lines, for example, wireless lines.

Since the communication lines can be considered to be a part of a network including the inboard LAN 13, this network will hereinafter be expressed as a network (communication network) 13 using the same reference sign as the inboard LAN 13. The communication lines may all be wireless, or at least some of them may be wired.

In addition, the bridge-side computer 14 is actually a computer constituting a part of a marine integrated bridge system installed inside a wheelhouse which is referred to as a bridge. For example, an ordinary desktop computer (including a computer main body, a display, a keyboard, a mouse, and the like) is used as the bridge-side computer 14. The marine integrated bridge system includes instruments used for acquiring and displaying a plurality of pieces of measurement information necessary to steer a ship, and instruments for steering (ship steering). In addition to the bridge-side computer 14, the marine integrated bridge system includes a plurality of computer main bodies and displays. The plurality of displays include a display for displaying radar measurement information and a display for displaying weather routing information.

The mobile terminal 16 is a generally used portable computer, for example, a tablet PC or a smartphone. The mobile terminal 16 is a representative of one of a plurality of mobile terminals.

The FBB terminal 15 is a kind of a ship-use satellite communication terminal including an antenna and supports broadband high-speed data communication, streaming data communication, and the like in addition to voice call services, FAX communication, and data communication service. The server 12, the bridge-side computer 14, other computers in the marine integrated bridge system, the mobile terminal 16, and the like connected to the inboard LAN 13 are constituted to be able to perform satellite communication with other ships and a ship user's side computer (a server and the like) in a remote location via the FBB terminal 15. Here, a ship user means a shipowner, an operating company, a charterer, a ship management company, a shipper, or the like.

In the present embodiment, data exchange between the server 12 or the bridge-side computer 14 and the ship user's side computer at a remote location is carried out through satellite communication via the FBB terminal 15, thereby enabling a digital twin of a hull structure. The hull structure digital twin is a system precisely reproducing the hull in a real sea area in a cyberspace and allows a person concerned to objectively evaluate the integrity of the hull based on information obtained from the digital twin. In addition, a digital twin means a technology of reproducing various data collected from the real world on a computer as if it were a twin.

Information exchange may be performed between the plurality of sensor devices 18 and the server 12 via other terminal devices connected to the network 13.

The plurality of sensor devices 18 are disposed in a predetermined locational relationship on shell constituent members which are measurement targets (objects), for example, an upper surface of a double bottom, and disposition of the sensor devices 18 will be further described below. Here, the term “shell” is often used synonymously with a hull. However, in this specification, it means a part which is sufficient to float on water, that is, a container-like structure (constituted of a bottom (a hull bottom surface and a lower surface), gunwales (hull side surface), and decks).

In the present embodiment, a generally used server computer is used as the server 12, but a cloud (computer) may be used. Since the server 12 also plays a role of collecting sensor data as described below, it is provided separately from the marine integrated bridge system. However, when the plurality of sensor devices 18 are connected to the network 13 through wired lines, for example, in the case of a constitution in which the server 12 can reliably collect sensor data from all the sensor devices 18, the server 12 may be installed inside the bridge.

The server 12 includes a CPU, a ROM, a RAM, an HDD, and the like (storages, not shown). For example, the CPU utilizes the RAM as a work domain and executes various processing algorithms regulated by various programs stored in the ROM, the HDD, and the like. The server 12 also functioning as an analysis device is not limited to the constitution of the present embodiment and need only include at least a constitution (or a function) capable of obtaining shape information of an object (including change over time in shape) through computation based on outputs of the plurality of sensor devices 18. In addition, the analysis device is not limited to hardware as in the present embodiment and may be software capable of executing at least a computational function, for example.

In addition, the server 12 obtains information of the shape of one surface (shape information) of an object (measurement target) upon reception of sensor data (including an ID) via the network 13 as described below.

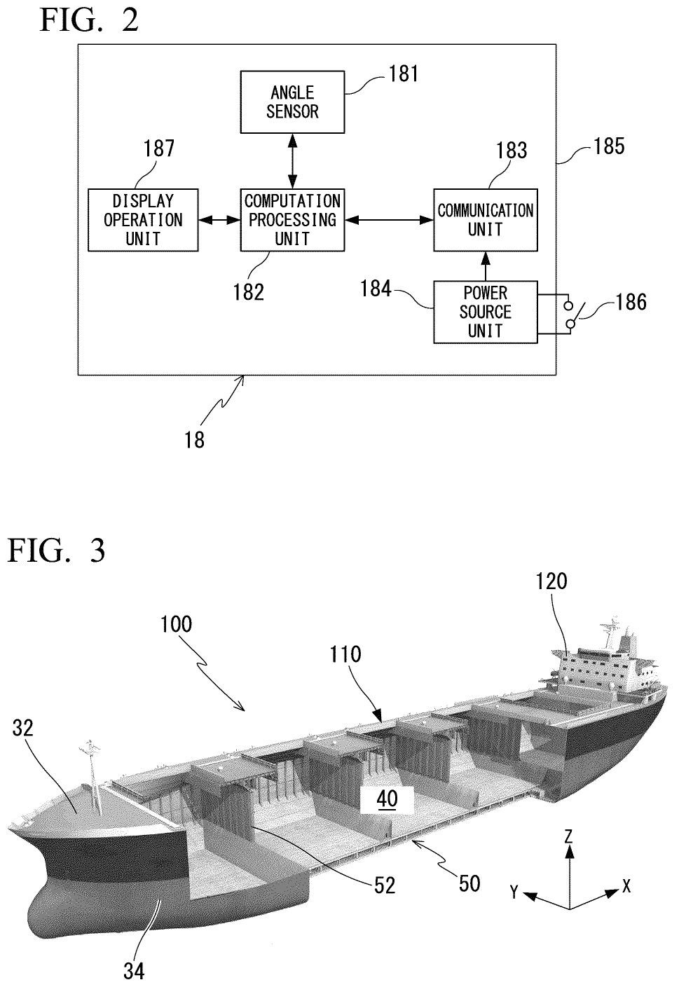

As shown in FIG. 2, each of the sensor devices 18 includes an angle sensor 181, a computation processing unit 182, a communication unit 183, and a power source unit 184 constituted of a battery, for example, as well as a waterproof casing 185 accommodating these therein. Power supplied from the power source unit 184 to each part of the sensor devices 18 can be turned on and off by operating a power source switch 186 provided in the casing 185. For example, the sensor device 18 further includes a display operation unit 187 constituted of a compact touch panel. The display operation unit 187 is connected to the computation processing unit 182 and plays roles of both an input device and a display device. A part of the display operation unit 187 is exposed on an outer surface of the casing 185. In the present embodiment, the communication unit 183 is constituted of a wireless communication unit performing wireless communication. However, the communication unit 183 is not limited to being wireless, and at least a part it may be wired. In addition, the sensor device 18 does not necessarily have to include the power source switch 186 and may be constituted such that the power source can be turned on and off by an operation from the outside (the server 12, the bridge-side computer 14, and the like). Moreover, it may be constituted such that the power source is not turned on and off. In addition, the sensor device 18 is not limited to the constitution of the present embodiment. It may not be integrally constituted of the angle sensor 181, the communication unit 183, and the like and need only have a function of measuring angle information at an installation location of at least the angle sensor 181, that is, the sensor device 18. For example, the angle sensor 181 and parts other than this (including the computation processing unit 182 and the like) may be constituted to be connected through wireless or wired communication lines such that measurement data from the angle sensor 181 is output via the communication lines and power is supplied to the angle sensor 181. In this case, there is no need to provide other parts for each angle sensor 181, and a plurality of angle sensors 181 may be connected to the same other parts via the communication lines. In addition, other terminal devices connected to the network 13 or the like may have the function of other parts.

In the present embodiment, as an example, a 3D MEMS (three-dimensional microelectromechanical system) tilt angle sensor is used as the angle sensor 181. The 3D MEMS tilt angle sensor is a precision tilt sensor created using 3D MEMS technology. The power required by the 3D MEMS tilt angle sensor is extremely low corresponding to the amount of power consumption in a microampere range, making it suitable for wireless application. As an example, a sensor into which two MEMS acceleration sensors with symmetrical output characteristics and an ASIC are built is used as the angle sensor 181, which outputs information of tilt angles (α, β, γ) in three directions (a θx direction, a θy direction, and a θz direction), for example. Here, the Ox direction, the Oy direction, and the θz direction are tilt/rotation directions around respective axes of an X axis, a Y axis, and a Z axis in the three-dimensional orthogonal coordinate system shown in FIG. 3. In the following description, a vertical direction (direction of gravity) is regarded as a Z axis direction, a direction in which the bow (front) and the stern (rear) are connected within a plane orthogonal to the Z axis, that is, a bow-stern line direction is regarded as an X axis direction, a hull width direction orthogonal to the Z axis and the X axis is regarded as a Y axis direction, and tilt (rotation) directions around the X axis, the Y axis, and the Z axis are respectively regarded as the Ox, Oy, and Oz directions.

The angle sensor is not limited to a 3D MEMS tilt angle sensor, and other kinds of three-dimensional tilt angle sensors may be used. In addition, the angle sensor is not limited to a three-dimensional tilt angle sensor depending on a measurement object, and a two-dimensional tilt angle sensor or a one-dimensional tilt angle sensor may be used. At this time, a two-dimensional tilt angle sensor and a one-dimensional tilt angle sensor may be used in combination, or a plurality of two-dimensional or one-dimensional tilt angle sensors may be used in combination.

For example, the computation processing unit 182 is constituted of a microcontroller (MCU) and has a CPU, a memory device (RAM, ROM), an input/output circuit, and a timer circuit (not shown). The computation processing unit 182 executes the processing algorithm defined by the program stored in the ROM. Without providing the computation processing unit 182, the ASIC built into the angle sensor 181 may also have the function of the computation processing unit 182.

Here, various means can be employed as means for attaching the sensor device 18 to an object depending on the kind of the object. For example, when an object is a member which can obtain a sufficient strength by screw fastening, for example, a metal, the sensor device 18 can be fixed to the object using screws (including bolts). Furthermore, depending on the kind of the object and the method of use, the sensor device 18 may be fixed to the object utilizing magnetic forces of magnets in place of screw fastening and bonding or together with screw fastening and bonding.

In the following description, appropriately, the sensor device 18 will be abbreviated as the sensor 18.

Here, a constitution of a bulk carrier (present ship) 100 which is a monitoring object, disposition of the sensors 18, and the like will be described. As an example, the present ship 100 has an overall length L of approximately 200 m, an overall width W of approximately 21 m, and a deadweight of approximately 55,000 tons.

FIG. 3 shows a perspective view of the present ship 100 in a state in which a part of a hull 110 is cut away. In addition to the hull 110, the present ship 100 includes various parts (for example, a mast and various other rigging, and the like) on an upper deck 32 constituting the hull 110, and an engine, as well as a bridge deck 120 and the like. Here, the bridge deck 120 is a superstructure in which the wheelhouse (steering house) referred to as a bridge is provided, and a cabin and the like are also provided in the bridge deck 120. The bridge is provided on a top floor of the bridge deck 120.

An upper deck (upper part deck) 32 is a deck leading from the bow to the stern and constitutes an upper surface member (lid) of the shell as a floating body of a watertight structure.

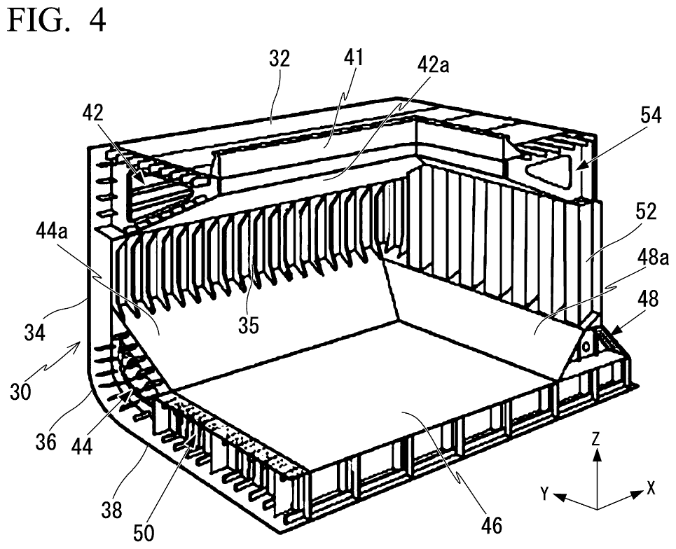

The present ship 100 includes five holds 40 partitioned by traverse bulkheads 52, and a ship bottom part is a double bottom 50. FIG. 4 is an extracted and enlarged cross-sectional perspective view of the hull showing a part of one hold 40 in FIG. 3. As is clear from this FIG. 4, an outer shell 30 of the hull 110 is constituted of the upper deck 32, side plates 34 (including bilge plates 36) on a port side and a starboard side, and a bottom plate 38.

Inside the outer shell 30, a top-side tank 42 forming (dividing) the holds 40, a hopper tank 44, an inner bottom plate 46, lower stools 48, the traverse bulkheads 52, upper stools 54, and the like are disposed. The top-side tank 42 is disposed in contact with the lower surface of the upper deck 32 and is provided on both sides of the hull with an upper tilt wall 42a as a bottom plate. The hopper tank 44 is provided on both sides of the hull with a lower tilt wall 44a as a top plate.

The inner bottom plate 46 is a member constituting a floor surface of the hold 40 in which bulk cargo (also referred to as bulk) is loaded, and end parts of the inner bottom plate 46 on the port side and the starboard side are connected to the lower tilt walls 44a on the port side and the starboard side (both sides). The inner bottom plate 46 is a plate member disposed on the inward side (upward side) of the bottom plate 38 in a bottom 50 of the double bottom structure and having the same thickness as the bottom plate 38 constituting the bottom surface of the hold 40. A plurality of kinds of strengthening members and the like extending in the bow-stern line direction (front-rear direction) or a lateral direction are disposed between the inner bottom plate 46 and the bottom plate 38. The double bottom 50 is constituted of these strengthening members, the inner bottom plate 46, and the bottom plate 38.

The strengthening members include a plurality of floors serving as main transverse strengthening members disposed at a predetermined interval in the bow-stern line direction and laterally extending, and a plurality of side girders, a center girder, and the like serving as main vertical strengthening members disposed at a predetermined interval in the lateral direction and extending in the front-rear direction.

The traverse bulkheads 52 are corrugated bulkheads partitioning the hull in the bow-stern line direction in order to form the holds 40 and are supported by the lower stools 48 below the upper stools 54 provided below the upper deck 32. Lower ends of tilt walls 48a of two (a pair of) lower stools 48 provided before and after the holds 40 are connected to the inner bottom plate 46.

The tilt wall 42a of the top-side tank 42 is formed to tilt toward a hatch coaming 41 such that a free surface of an upper part having the largest movement is reduced in order to restrict the movement of bulk due to rolling of the hull. Tilt walls of the upper stools 54 are also formed to tilt toward the hatch coaming 41 for the same reason.

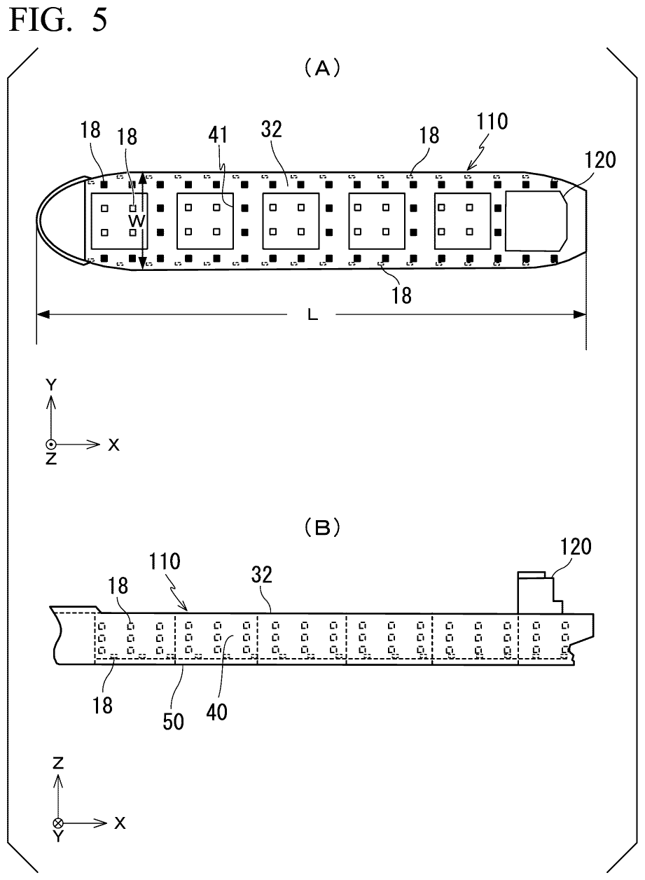

Part (A) of FIG. 5 shows a plan view of the hull 110 of the present ship 100, and part (B) of FIG. 5 shows the left side view (a view from the port side) of the hull 110. The view on the starboard side is omitted, and it is similar to that on the port side although it is reversed from left to right of the port.

In part (A) of FIG. 5 and part (B) of FIG. 5, the exterior of the hull 110 is shown together with the bridge deck 120. In FIG. 5(A), the reference sign 41 indicates the hatch or the hatch coaming. The hatch means an opening provided for carrying in and out cargo with respect to the cargo hold or other divisions of the ship or for people to enter and exit the ship. In FIG. 5(A), illustration of a hatch cover and the like is omitted.

Next, disposition of the sensors 18 will be described.

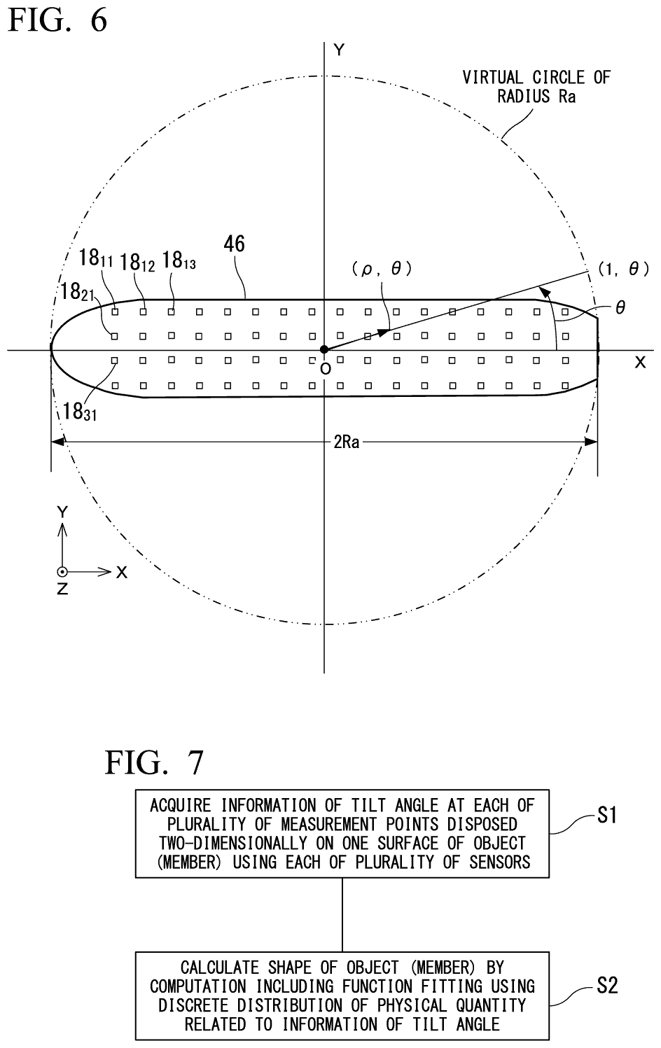

As shown in parts (A) and (B) of FIG. 5, as an example, the plurality of sensors 18 are disposed in a predetermined locational relationship on the upper surface of the upper deck 32 and the upper surface of the double bottom 50. In FIG. 5(A), black squares (▪) indicate the sensors 18 disposed on the upper deck 32, and white squares (□) shown within the hatches 41 indicate the sensors 18 disposed on the upper surface of the double bottom 50. The plurality of sensors 18 are disposed in matrix disposition on the upper surface of the double bottom 50 (refer to FIG. 6). However, in FIG. 5(A), some of them are shown, and the remaining sensors 18 are located on the deep side (of this page) from the sensors 18 on the upper deck 32. Furthermore, the plurality of sensors 18 are individually disposed in a predetermined locational relationship on the inner surface of each of the side plates 34 on the port and starboard sides (including the bilge plates). Disposition of the sensors 18 on the side plates 34 on the port side and the starboard side is disposition of bilateral symmetry. However, such disposition may not be adopted.

In the present embodiment, each of the sensors 18 is adsorbed and fixed to the upper surface of the upper deck 32, the upper surface of the double bottom 50, and the inner surfaces of the left and right side plates 34, for example, by screw fastening or magnetic forces of magnets. The attachment location of each of the sensors 18 is consistent with locations of measurement points set in advance by the server 12. That is, the location of each of the measurement points is marked, and each of the sensors 18 is attached in the location of the mark. The location coordinates of the measurement points (for example, (x, y) on the upper deck 32 and the upper surface of the double bottom) are managed by the server 12.

The sizes, the disposition, the number, and the like of the sensors 18 shown in part (A) of FIG. 5 and part (B) of FIG. 5 and other diagrams are not consistent with actual ones on the present ship 100. That is, part (A) of FIG. 5 and part (B) of FIG. 5 and the like show an example of disposition of the sensors.

In the case of a bulk carrier such as the present ship 100, unpackaged bulk cargo such as grains, ores, and cement is transported in the holds 40. For this reason, when the sensors 18 are attached to the upper surface of the double bottom 50 (the upper surface of the inner bottom plate 46), it is desirable to take countermeasures such as the sensor surface with durable protective covers to prevent the sensors 18 from malfunctioning due to contact with bulk cargo, or the like. Alternatively, if possible, countermeasures such as changing the attachment locations of the sensors 18 to places where they do not come into contact with bulk cargo (not affected by bulk cargo) may be taken. For example, in the case of a new ship, the sensors 18 may be attached to the lower surface of the inner bottom plate 46. In this case, contact between bulk cargo and the sensors 18 can be avoided regardless of the kind of bulk cargo.

In addition, when the sensors 18 are disposed on the side plates 34, the sensors 18 may be disposed in regions between adjacent frames 35 (refer to FIG. 4) on the inner surfaces of the side plates 34.

In the present embodiment, when the hull structure is monitored, deformation information of the shell constituent member in which the sensors 18 are disposed (specifically, the upper deck 32, the inner bottom plate 46 constituting the upper surface of the double bottom 50, and the side plates 34 of the port and the starboard) is used. However, deformation information of the shell constituent member is obtained from the shapes of the hull constituent members in which the sensors 18 are disposed. Therefore, hereinafter, a method for obtaining the shape of one surface of the shell constituent member in which the sensors 18 are disposed will be described. Here, the inner bottom plate 46 (which will hereinafter be expressed as the member 46) will be taken as a measurement target member.

FIG. 6 shows the simplified measurement target member (inner bottom plate) 46. Each of the plurality of sensors 18 is fixed to the location of each of the plurality of measurement points (this location is set in advance by the server 12 based on design data) set in a predetermined locational relationship on one surface (upper surface) of the member 46. Here, as an example, the plurality of sensors 18 are disposed in a matrix shape with the X axis direction as a row direction (a direction in which the column number changes) and with the Y axis direction as a column direction (a direction in which the row number changes). Hereinafter, they are set as a first row, a second row, a third row, and so on in order from the top to the bottom in FIG. 6 and are set as a first column, a second column, a third column, and so on in order from the left to the right. In addition, for the sake of identification, the sensor 18 located in an ith row and a jth column is expressed as the sensor 18ᵢⱼ. In FIG. 6, the reference signs are applied to only some of the sensors located in the first row and some of the sensors located in the first column.

Disposition of the plurality of sensors 18 is actually set such that the respective sensors 18 are disposed at the plurality of measurement points in different locations in one of two directions intersecting each other within one surface of a measurement target (object) depending on the shape of the object, the structure of the hull, and the like. However, here, for the sake of convenience of description, matrix disposition is adopted.

Next, a flow of a method for acquiring the shape of a member (object), which is a premise for hull structure monitoring according to the present embodiment, will be described based on FIG. 7.

Regarding a prerequisite for starting shape acquisition, the object, here, as described above, in the member 46, the plurality of sensors 18ᵢⱼ are disposed in a matrix shape with the X axis direction as the row direction (a direction in which the column number changes) and with the Y axis direction as the column direction (a direction in which the row number changes), and it is assumed that each sensor 18ᵢⱼ is calibrated in advance (before attachment) to prevent measurement errors.

In addition, each sensor 18ᵢⱼ is subjected to necessary initial settings in advance by a worker at the time of attachment after the power source is turned on such that communication can be performed via the network 13. The initial settings of the sensors 18ᵢⱼ include inputting identification information of the sensors 18ᵢⱼ via the display operation unit 187. Specifically, identification information (01-ij) is individually input to the sensors 18ᵢⱼ in the ith row and the jth column, and each computation processing unit 182 stores the input identification information in an internal memory (RAM). Here, “01” of the identification information is the identification number of the member 46 which is a measurement target, and “ij” is the identification number of each sensor 18ᵢⱼ and is also information indicating disposition location of each sensor 18ᵢⱼ. For example, pieces of identification information (01-11), (01-12), and (01-13) are individually input to each of three sensors 1811, 1812, and 1813 in the first row shown in FIG. 6. The disposition location of each sensor 18ᵢⱼ indicated by the identification number ij is recognized by the server 12. Upon completion of the initial settings, each sensor 18ᵢⱼ is in a standby state in which it is ready to perform measurement at any time. After the initial settings, it is assumed that the power source is kept in an ON state.

Under this premise, information of the tilt angle at each of the plurality of measurement points disposed two-dimensionally on one surface of the member 46 is acquired using each of the plurality of sensors 18ᵢⱼ (Step S1 in FIG. 7).

Subsequently, the shape of the member 46 is calculated by computation including function fitting using a discrete distribution of the physical quantity related to the acquired information of the tilt angle (Step S2 in FIG. 7). Hereinafter, the processing of Step S2 will be described in detail.

In the present embodiment, the shape of one surface to which the sensor 18 of the member 46 is attached (which will hereinafter be referred to as a measurement surface) is calculated as the shape of the object (member 46). The shape of the measurement surface can be said to express an in-plane distribution of the amount of deformation of the member 46 (in other words, the amount of deviation with respect to the reference surface).

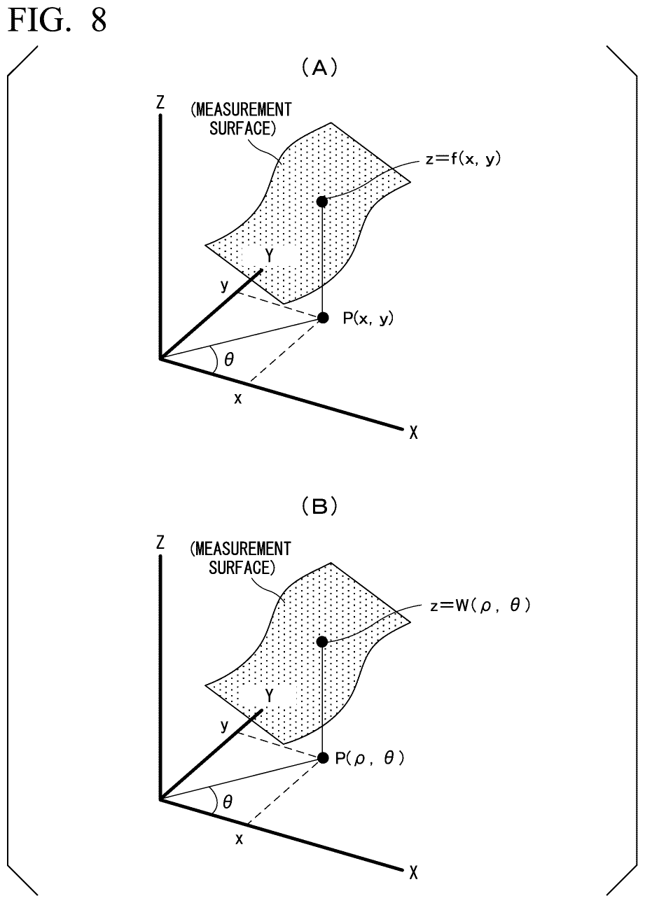

As shown in part (A) of FIG. 8, the measurement surface corresponds to a set of points in a Z location z at a point P (x, y) on an XY plane on a three-dimensional orthogonal coordinate system (x, y, z) and can be expressed by a function z=f(x, y). Meanwhile, as shown in part (B) of FIG. 6, the point P is expressed as P(ρ, θ) on a polar coordinate system (x=ρ cos θ, y=ρ sinθ). Therefore, the measurement surface can be expressed as z=W(ρ, θ) on the polar coordinate system (x=ρ cos θ, y=ρ sinθ). Hereinafter, appropriately, the measurement surface can also be expressed as a measurement surface W or a measurement surface W(ρ, θ).

Tilt angles α, β, and γ in the three directions (the Ox direction, the Oy direction, and the Oz direction) at the attachment locations thereof can be obtained as outputs of the respective sensors 18ᵢⱼ, which are nothing but tilt angles of normal vectors on the measurement surface W at the measurement points of the respective sensors 18ᵢⱼ. However, in the following description related to the shape measurement of the member 46, the θz direction is not taken into consideration.

The shape of the measurement surface of the object (surface shape) can be derived from the measurement point coordinates and the measurement values of the tilt angles of the normal vectors. For example, an amount of deviation z (that is, a height z from the reference surface, which will hereinafter be appropriately expressed as the height z) of each of the measurement points with respect to the reference surface (XY plane) is obtained using the gradient of the surface slope at each of the measurement points (coordinates (x, y)) and the first order integral thereof, or by geometric calculation or the like. Accordingly, information of an in-plane distribution of the amount of deviation z with respect to the discrete reference surface at the plurality of measurement points can be obtained. However, in this stage, information of the height z at points other than the points where the sensors 18 are disposed can only be obtained approximately by proportional calculation or the like, and it is difficult to accurately obtain the information. In addition, for example, when the sensors 18 are not disposed at the locations where the height z is maximized, it is also difficult to obtain the largest value of the height z.

Therefore, in the present embodiment, it is assumed that discrete information is fitted to a function to obtain a function expressing the measurement surface W. In fitting using a function, a function of an arbitrary orthogonal polynomial can be used. By using an orthogonal polynomial, it becomes possible to uniquely confirm the amount of deformation and the location where the deformation occurs.

In the present embodiment, a Zernike polynomial is used as an orthogonal polynomial. A Zernike polynomial is an orthogonal polynomial defined on a unit circle.

Hereinafter, a first method using a Zernike polynomial will be described.

### <<First Method>>

The Zernike polynomial is defined by the following expression.

$$\begin{matrix}[ Math . 1 ] & \\ {Z}_{n}^{m} ( ρ , θ ) = \{ \begin{matrix}{R}_{n}^{m} ( ρ ) cos ( m θ ) & m \geq 0 \\ {R}_{n}^{\vert m \vert} ( ρ ) sin ( \vert m \vert θ ) & m < 0\end{matrix} & ( 1 )\end{matrix}$$

In the foregoing Expression (1), n is a non-negative integer, m is an integer satisfying n≥|m|, ρ is a radius vector (0≤ρ≤1), and θ is an angle of deflection.

The Zernike polynomial falls within the range of |Zₙ^{m}(ρ, θ)|≤1. Here, when n-m is an even number, the radial polynomial Rₙ^{m} (φ is defined as the following Expression (2).

$$\begin{matrix}[ Math . 2 ] & \\ {R}_{n}^{m} ( ρ ) = {\sum }_{s = 0}^{\frac{n - m}{2}} \frac{{( - 1 )}^{s} ( n - s ) !}{s ! ( \frac{n + m}{2} - s ) ! ( \frac{n - m}{2} - s ) !} {ρ}^{n - 2 s} & ( 2 )\end{matrix}$$

In addition, when n-m is an odd number, it is defined as zero.

Here, the Fringe notation is employed to integrate two indices n and m into one index i.

That is, in the Fringe Zernike polynomial, the index i is defined as follows.

$$\begin{matrix}[ Math . 3 ] & \\ i = {( 1 + \frac{n + \vert m \vert}{2} )}^{2} - 2 \vert m \vert + \frac{1 - sgn m}{2} & ( 3 )\end{matrix}$$

Table 1 shows a relationship between the indices n, m, and i of the first few terms of the Fringe Zernike polynomial obtained in accordance with the foregoing Expression (3).

TABLE 1

| | | | | | | | | | | | | | | | | | | | | |
|---|---|---|---|---|---|---|---|---|---|---|---|---|---|---|---|---|---|---|---|---|
| n | 0 | 1 | 1 | 2 | 2 | 2 | 3 | 3 | 4 | 3 | 3 | 4 | 4 | 5 | 5 | 6 | 4 | 4 | 5 | 5 |
| m | 0 | 1 | −1 | 0 | 2 | −2 | 1 | −1 | 0 | 3 | −3 | 2 | −2 | 1 | −1 | 0 | 4 | −4 | 3 | −3 |
| i | 1 | 2 | 3 | 4 | 5 | 6 | 7 | 8 | 9 | 10 | 11 | 12 | 13 | 14 | 15 | 16 | 17 | 18 | 19 | 20 |

In this specification, appropriately, each term of the Fringe Zernike polynomial is expressed as Zᵢ(ρ, θ). Therefore, the measurement surface W(ρ, θ) can be expressed as the following expression.

$$\begin{matrix}[ Math . 4 ] & \\ W ( ρ , θ ) = {\sum }_{i} {k}_{i} \cdot {Z}_{i} ( ρ , θ ) & ( 4 )\end{matrix}$$

kᵢ is a coefficient of each term Zᵢ(ρ, θ).

Zᵢ(ρ, θ) is shown in Table 2, up to the 37th term, together with the coefficient kᵢ.

TABLE 2

| kᵢ | Zᵢ |
|---|---|
| k₁ | 1 |
| k₂ | ρcosθ |
| k₃ | ρsinθ |
| k₄ | 2ρ² − 1 |
| k₅ | ρ²cos2θ |
| k₆ | ρ²sin2θ |
| k₇ | (3ρ³ − 2ρ) cosθ |
| k₈ | (3ρ³ − 2ρ) sinθ |
| k₉ | 6ρ⁴ − 6ρ² + 1 |
| k₁₀ | ρ³cos3θ |
| k₁₁ | ρ³sin3θ |
| k₁₂ | (4ρ⁴ − 3ρ²) cos2θ |
| k₁₃ | (4ρ⁴ − 3ρ²) sin2θ |
| k₁₄ | (10ρ⁵ − 12ρ³ + 3ρ) cosθ |
| k₁₅ | (10ρ⁵ − 12ρ³ + 3ρ) sinθ |
| k₁₆ | 20ρ⁶ − 30ρ⁴ + 12ρ² − 1 |
| k₁₇ | ρ⁴cos4θ |
| k₁₈ | ρ⁴sin4θ |
| k₁₉ | (5ρ⁵ − 4ρ³) cos3θ |
| k₂₀ | (5ρ⁵ − 4ρ³) sin3θ |
| k₂₁ | (15ρ⁶ − 20ρ⁴ + 6ρ²) cos2θ |
| k₂₂ | (15ρ⁶ − 20ρ⁴ + 6ρ²) sin2θ |
| k₂₃ | (35ρ⁷ − 60ρ⁵ + 30ρ³ − 4ρ) cosθ |
| k₂₄ | (35ρ⁷ − 60ρ⁵ + 30ρ³ − 4ρ) sinθ |
| k₂₅ | 70ρ⁸ − 140ρ⁶ + 90ρ⁴ − 20ρ² + 1 |
| k₂₆ | ρ⁵cos5θ |
| k₂₇ | ρ⁵sin5θ |
| k₂₈ | (6ρ⁶ − 5ρ⁴) cos4θ |
| k₂₉ | (6ρ⁶ − 5ρ⁴) sin4θ |
| k₃₀ | (21ρ⁷ − 30ρ⁵ + 10ρ³) cos3θ |
| k₃₁ | (21ρ⁷ − 30ρ⁵ + 10ρ³) sin3θ |
| k₃₂ | (56ρ⁸ − 105ρ⁶ + 60ρ⁴ −10ρ²) cos2θ |
| k₃₃ | (56ρ⁸ − 105ρ⁶ + 60ρ⁴ − 10ρ²) sin2θ |
| k₃₄ | (126ρ⁹ − 280ρ⁷ + 210ρ⁵ −60ρ³ + 5ρ) cosθ |
| k₃₅ | (126ρ⁹ − 280ρ⁷ + 210ρ⁵ − 60ρ³ + 5ρ) sinθ |
| k₃₆ | 252ρ¹⁰ − 630ρ⁸ + 560ρ⁶ − 210ρ⁴ + 30ρ² − 1 |
| k₃₇ | 924ρ¹² − 2772ρ¹⁰ + 3150ρ⁸ − 1680ρ⁶ + 420ρ⁴ − 42ρ² + 1 |

Here, since Expression (4) is obtained as many times as the number of sensors 18 (the number of measurement points), the second term to the qth term (for example, the 37th term) of the Zernike polynomial are used for fitting, the number of sensors 18 is set to K (K>q−1), and z obtained at the measurement point of each of the K sensors 18 is subjected to function fitting. That is, the coefficient kᵢ (i=2, 3, and so on to q) of each term of Expression (4) is obtained by solving K observation equations. Here, since z includes an error, in order to reduce the error included in the coefficient kᵢ as much as possible, it is obtained by the least squares method.

In the present first method, by the technique described above, the coefficient kᵢ of each term of the function W(ρ, θ) is obtained, and the function W(ρ, θ) after the coefficient kᵢ is confirmed is obtained as a function expressing the shape of the surface of the object, that is, the distribution of the amount of deformation. According to this first method, information of the height z at points other than the points where the sensors 18 are disposed can be obtained from the function z=W(ρ, θ) without performing proportional calculation. Furthermore, for example, even when the sensors 18 are not disposed in the most protruding location, the most protruding location and the protruding amount can be obtained from the function z=W(ρ, θ).

### <<Second Method>>

Incidentally, the tilt angles α and β of the normal vectors in the θx and θy directions on the measurement surface at each of the measurement points (outputs of the sensors 18) are nothing but the gradient of the tangential plane at each of the measurement points on the measurement surface expressed by the function z=W(ρ, θ) and can also be expressed as the gradients α=∂W/∂x and β=∂W/∂y. Here, ∂W/∂x and ∂W/∂y are differential coefficients of the function W.

Therefore, in place of the foregoing first method, a function dW(ρ, θ) expressing the distribution of the measurement values of the sensors 18 can be obtained, by fitting the discrete measurement values of the sensors 18 to a function obtained by differentiating the Zernike polynomial (in this specification, which will also be referred to as a differential Zernike polynomial). The function W(ρ, θ) can be obtained by integrating the obtained dW(ρ, θ).

Hereinafter, a second method using a differential Zernike polynomial will be simply described.

The distribution dW(ρ, θ) of the measurement values can be expressed as Expression (5) using the differential Zernike polynomial.

$$\begin{matrix}[ Math . 5 ] & \\ d W ( ρ , θ ) = {\sum }_{i} {k}_{i} \cdot {Z}_{i}^{′} ( ρ , θ ) & ( 5 )\end{matrix}$$

Actually, the tilt angles α=∂W/∂x and β=∂W/∂y can be obtained for each of the sensors 18.

The x partial differential ∂Z/∂x in Expression (1) is expressed as follows.

$$\begin{matrix}[ Math . 6 ] & \\ \frac{\partial Z}{\partial x} = \frac{\partial }{\partial x} ( {R}_{n}^{m} ( ρ ) cos ( m θ ) ) ( m \geq 0 ) & ( 6 )\end{matrix}$$

$$\frac{\partial Z}{\partial x} = \frac{\partial }{\partial x} ( {R}_{n}^{m} ( ρ ) sin ( \vert m \vert θ ) ) ( m < 0 )$$

The y partial differential ∂Z/∂y in Expression (1) is expressed as follows.

$$\begin{matrix}[ Math . 7 ] & \\ \frac{\partial Z}{\partial y} = \frac{\partial }{\partial y} ( {R}_{n}^{m} ( ρ ) cos ( m θ ) ) ( m \geq 0 ) & ( 7 )\end{matrix}$$

$$\frac{\partial Z}{\partial y} = \frac{\partial }{\partial y} ( {R}_{n}^{m} ( ρ ) sin ( \vert m \vert θ ) ) ( m < 0 )$$

In addition, the polar coordinates of the differentiates ∂/∂x and ∂/∂y are indicated as Expression (8). In Expression (6) and Expression (7), when m=0, cos(mθ)=1.

$$\begin{matrix}[ Math . 8 ] & \\ \frac{\partial }{\partial x} = cos θ \frac{\partial }{\partial ρ} - \frac{1}{ρ} sin θ \frac{\partial }{\partial θ} & ( 8 )\end{matrix}$$

$$\frac{\partial }{\partial y} = sin θ \frac{\partial }{\partial ρ} + \frac{1}{ρ} cos θ \frac{\partial }{\partial θ}$$

Expression (8) is applied to the foregoing Expressions (6) and (7) and calculation is performed to obtain general systems of the nth order mθ term of variable differentials of Z, ∂Z/∂x and ∂Z/∂y, and the indices m and n of each of the obtained terms are integrated into one index i in accordance with Expression (3). The terms are rearranged in the order of the integrated indices so that each term of a differential Zernike polynomial Z′(ρ, θ) obtained by differentiating the Fringe Zernike polynomial can be obtained.

In the present embodiment, the Zernike polynomial and the differential Zernike polynomial, as well as the expressions of these respective terms, can be obtained in advance and are stored in the storage of the server 12.

The discrete measurement values (∂W/∂x, ∂W/∂y) of the sensors 18 are subjected to the function fitting to the polynomial in the foregoing Expression (5), and the coefficient kᵢ of each term is obtained using the least squares method. At this time, if the number of sensors 18 is K, the number of observation equations becomes 2K. Accordingly, the coefficient kᵢ of each term in the polynomial in Expression (5) can be obtained. In this second method, since no calculation (approximation calculation) for obtaining the height z from the measurement values of the sensors 18 is performed, the obtained value of the coefficient kᵢ has a smaller error with respect to the true value than that in the first method.

Further, the obtained coefficient of each term is set as the determination coefficient kᵢ of each corresponding term in Expression (5), and the function W(ρ, θ) is obtained by integrating the polynomial in Expression (5) after the coefficient is confirmed.

$$\begin{matrix}[ Math . 9 ] & \\ \int d W ( ρ , θ ) = W ( ρ , θ ) = {\sum }_{i} {k}_{i} \cdot {Z}_{i} ( ρ , θ ) & ( 9 )\end{matrix}$$

The function of Expression (9) obtained as a result of integration should be consistent with the function W(ρ, θ) obtained by substituting the determination coefficient kᵢ of each term in this case into Expression (4).

According to the present second method, similar to the first method, information of the height z at points other than the points where the sensors 18 are disposed can also be obtained from the function z=W(ρ, θ) without performing proportional calculation. Furthermore, for example, even when the sensors 18 are not disposed in the most protruding location, the most protruding location and the protruding amount can be obtained from the function z=W(ρ, θ). In addition to this, since the error of kᵢ with respect to the true value is smaller than that in the first method, the shape of the surface expressed by W(ρ, θ) can be accurately obtained.

In measurement in which an actual hull constituent member becomes a measurement target (object), as shown in FIG. 6, a virtually set circle (virtual circle) of the radius Ra circumscribing the object, here, the member 46 is set, and an XY coordinate system is set with the center of this circle as an origin O. Further, this XY coordinate system is subjected to coordinate conversion into a polar coordinate system (ρ, θ) in which the virtual circle of the radius Ra is the unit circle (0≤ρ≤1). This polar coordinate system is used in the first method and the second method described above. In a polar coordinate system, the angle from the axis corresponding to the X axis is the angle of deflection θ.

When the location of a certain measurement point where the sensor 18 is disposed is (a, b) on the XY coordinate system, the calculated coordinate location of the measurement point is set to (a/Ra, b/Ra), and various calculation such as the function fitting described above are performed.

In the present embodiment, as shown in part (A) of FIG. 5 and part (B) of FIG. 5, a plurality of sensors 18 are disposed two-dimensionally (in a predetermined locational relationship) on each of the upper deck 32 and one surface (inner surface) of the side plates 34 on the port side and the starboard side, and the shape information of each part can be acquired by a technique similar to the member 46. However, in the side plates 34 on the port side and the starboard side, an XZ plane is used as a reference surface to obtain the amount of deviation (in-plane distribution of the amount of deformation), that is, the shape information of one surface, and at this time, sensor data including the tilt angles in the θx direction and the θz direction measured by each of the sensors 18 is used.

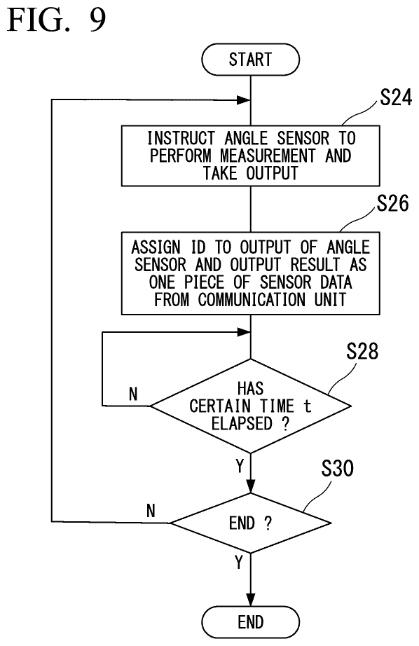

Next, operation of each of the sensors 18 will be described based on the flowchart in FIG. 9. This flowchart shows a processing algorithm defined by a program executed by the CPU of the computation processing unit 182. It is assumed that the processing algorithm corresponding to this flowchart starts when an instruction to start measurement is input from the server 12.

First, in Step S24, the angle sensor 181 is instructed to perform measurement, and information of the tilt angle measured by the angle sensor 181 (in at least two directions including the θx direction and the θy direction when the inner bottom plate 46 or the upper deck 32 is an object, and in at least two directions including the θx direction and the θz direction when the left and right side plates 34 are objects) is taken.

Next, in Step S26, an ID (identification code) is assigned to the taken output information, and it is transmitted to the server 12 via the communication unit 183 and the network 13 as one piece of sensor data. In addition to an ID, the sensor data also includes a time (substantially consistent with a measurement time). Regarding an ID, a number (code) input by a worker at the time of the initial settings and created based on the identification information stored in the RAM is used.

Next, in Step S28, after the angle sensor is instructed to perform measurement in Step S24, the processing waits for a certain time (corresponding to a sampling interval) t to elapse, and if the certain time t has elapsed, the processing proceeds to Step S30.

In Step S30, it is judged whether or not ending has been instructed, and when the result is negative, the processing returns to Step S24. Thereafter, the processing (including judgment) of the loop of Steps S24 to S30 is repeated until the judgment in Step S30 becomes affirmative. When the judgment in Step S30 becomes affirmative, the series of processing ends.

The foregoing processing of Steps S24 to S30 is performed for all the sensors 18.

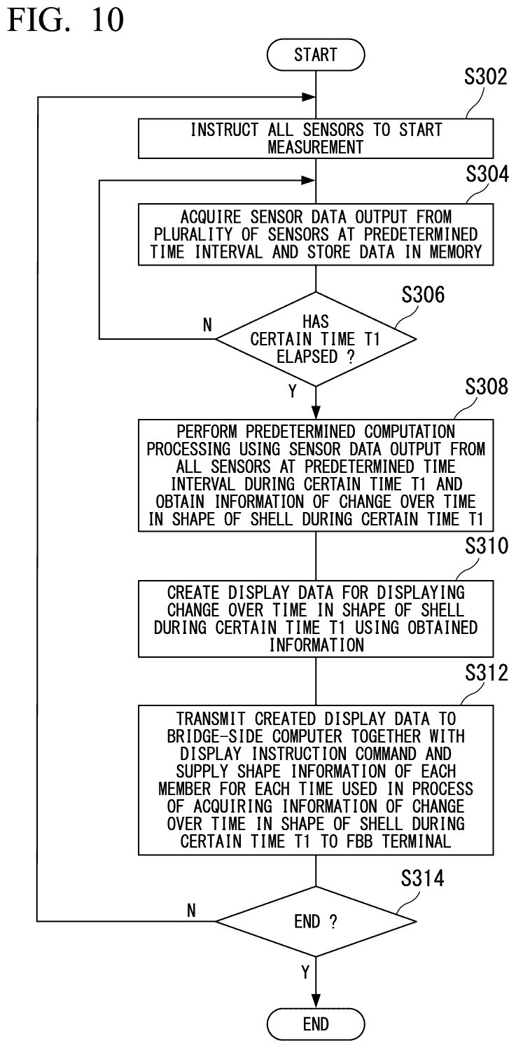

Next, control operation of (the CPU of) the server 12 during hull monitoring will be described based on the flowchart in FIG. 10. The flowchart in FIG. 10 shows a processing algorithm defined by a program executed by the CPU of the server 12. It is assumed that the processing algorithm shown in the flowchart in FIG. 10 starts when an instruction to start measurement is input from the bridge-side computer 14.

First, in Step S302, all the plurality of sensors 18 are instructed to start measurement. Accordingly, each of the plurality of sensors 18 starts measurement at the predetermined sampling interval t (FIG. 9 refer to). Here, the predetermined sampling interval is the certain time t, but it may not be a certain time.

In the following loop of Step S304 and Step S306, the sensor data output from each of the plurality of sensors 18 at a predetermined time interval (sampling interval) is acquired until a certain time T1 elapses after an instruction to start measurement has been issued to all the sensors 18, and it is stored in the memory. At this time, the server 12 sequentially stores the acquired sensor data in a predetermined storage domain of the RAM. When a plurality of pieces of sensor data are sent at the same time, the server 12 stores the sensor data simultaneously and in parallel in the predetermined storage domain of the RAM by time sharing processing.

Further, if the certain time T1 has elapsed, the processing proceeds to Step S308, and information of (rough) change over time in shape of the shell of the hull 110 during the certain time T1 is obtained by performing predetermined computation processing using the sensor data output from all the sensors 18 at a predetermined time interval during the certain time T1. More specifically, for all the measurement target members, that is, for each of the upper deck 32, the inner bottom plate 46, and the side plates 34 of the port and the starboard, each surface shape (distribution of the amount of deformation) W expressed by the polynomial in Expression (4) or Expression (9) is calculated using the sensor data taken at the same sampling time by the first method or the second method described above as the shape information of the object member for each time (each sampling time). Further, the shape (three-dimensional shape) of the shell is obtained for each time based on the shapes of the four members, and the data of the shape (three-dimensional shape) of the shell for each time is rearranged in time series to obtain information of (rough) change over time in shape of the shell during the certain time T1.

Further, next, in Step S310, display data for displaying change over time in shape of the shell during the certain time T1 is created using the information obtained in Step S308.

Next, in Step S312, the created display data is transmitted to the bridge-side computer 14 together with a display instruction command, and the shape information (information of the Zernike polynomial in Expression (4) or Expression (9) described above) of each member for each time used in the process of acquiring the information of change over time in shape of the shell during the certain time T1 (Step S308) is supplied to the FBB terminal 15. Accordingly, an image displaying change over time in shape of the shell is displayed on a display screen of the bridge-side computer 14. This image shows a state of change over time, such as vertical bending, transverse bending, and torsional deformation of the shell (hull), and it is one of pieces of information which will help a ship operator (captain or first mate) or the like who has seen this to steer the ship. For example, the ship operator can intuitively control the steering angle (and control the acceleration and deceleration of the main engine speed) as necessary by looking at the image display change over time in shape of the shell (hull).

Meanwhile, the FBB terminal 15, to which the shape information of each member for each time used for creating the display data has been supplied, converts the supplied information into data for wireless communication and transmits it to the ship user's side computer by satellite communication via the antenna. In the ship user's side computer (constituted of a computer capable of high-speed computation), the received data can be used for various application. For example, in consideration of the received data, an objective function of automatic operation (automatic steering and automatic speed control) of the ship is corrected, and information of a target steering angle and/or a target speed obtained from the corrected objective function is converted into data for wireless communication and is transmitted to the FBB terminal 15 of the ship 100 by satellite communication. In the FBB terminal 15, for example, the received data is converted into display information and is transmitted to the bridge-side computer 14 together with a display instruction command. Accordingly, information of the target steering angle and/or the target speed is displayed on the display screen of the bridge-side computer 14. The ship operator who has seen the display in the screen can adjust the target steering angle and/or the target speed without relying on intuition.

Furthermore, in the ship user's side computer, the received data (data of the shape information of each member for each time used for creating the display data) can be utilized, for example, in a hull structure digital twin system or the like. In the hull structure digital twin system, utilization of the data of the shape information of each member for each time described above will be described below.

Next, in Step S314, it is judged whether or not an instruction to end the processing has been input, and when this judgment is negative, the processing returns to Step S302. Thereafter, the processing (including judgment) of the loop of Step S302 to Step S314 is repeatedly performed until the judgment in Step S314 becomes affirmative.

Meanwhile, if an instruction to end the processing is input from the bridge-side computer 14 and the judgment in Step S314 becomes affirmative, an instruction to end measurement is issued to all the sensors 18, and then the series of processing ends.

When monitoring is performed over a long period of time, power supply (power feeding) to each of the sensors 18 is required. However, regarding a solution in this case, power feeding using an MEMS vibration generator, wireless power feeding (non-contact power feeding) of transmitting power utilizing an induced magnetic flux generated between the power transmission side and the power reception side in an electromagnetic induction method, power generation using solar power, wired LAN power feeding using a LAN cable, or the like can be considered.

As is clear from the above description, according to the hull structure monitoring system 10 of the present embodiment, a method for monitoring change in shape of a hull of a ship including measuring the tilt angle of one surface at each of the plurality of measurement points in locations different from each other within one surface of the member constituting the shell of the hull 110 at a predetermined sampling interval using the plurality of sensors 18, and acquiring information of change over time in shape of the member by performing predetermined computation processing using information of the tilt angle of one surface at each of the plurality of measurement points measured at the predetermined sampling interval and corresponding locational information at the plurality of measurement points is realized.

As described above in detail, according to the hull structure monitoring system 10 of the present embodiment and the monitoring method executed by the system 10, information of the shape of the hull 110 or a part thereof and change over time can be acquired with outstandingly higher accuracy than when double integration of acceleration is performed during navigation or the like of the ship (present ship 100) at sea. In addition, it is possible to acquire not only local deformation in the hull 110 or some constituent members thereof but also information of the overall shape and change over time therein.

In addition, the ship operator on the bridge can use information of the overall shape of the hull 110 or some constituent members thereof and change over time therein for more accurate ship steering. For example, since the influence of a vertical bending moment, a transverse bending moment, and a torsional moment acting on the hull 110 can be recognized from the information of the shape of the hull 110 and/or change over time therein, the information of these moments is further taken into consideration in addition to the weather routing information and radar measurement information, it is possible to steer the ship with higher accuracy than when information of the shape of the hull 110 and/or change over time therein cannot be recognized. In addition, it is also possible to intuitively recognize the presence or absence of occurrence of slapping and whipping of the hull from information of the shape of the hull 110 and/or change over time therein.

In addition, according to the present embodiment, it is possible to measure the amount of fluctuation over time in the amount of deformation in the shell constituent member under the operating conditions of an actual hull, which provides important data in structure design of the hull.

In the foregoing embodiment, a case in which a plurality of sensors 18 are disposed on all four members, such as the upper deck 32, the constituent member (inner bottom plate 46) of the double bottom 50, and the side plates 34 on the port side and the starboard side, shaping (forming) the shell of the hull 110, information of the shape of four members/change over time in shape is obtained based on the sensor data, and information of the shape of the shell/change over time in shape is acquired from this information has been described. However, it is not limited to this. The plurality of sensors may be disposed on only one of the upper deck 32 and the constituent member (inner bottom plate 46) of the double bottom 50, and information of the shape of the one member and change over time in shape may be acquired based on the sensor data. Even in such a case, it is possible to estimate a vertical bending deformation state occurring in the shell. In addition, a plurality of sensors may be disposed only on at least one of the side plates 34 on the port side and the starboard side, and information of the shape of the side plates 34 on the port side and/or the starboard side/change over time in shape may be acquired based on the sensor data. In such a case, it is possible to estimate a transverse bending deformation state occurring in the shell.

In the foregoing embodiment, a case in which the present ship 100 can perform data communication with the ship user side in a remote location through satellite communication has been described. However, a satellite communication facility or the like does not necessarily have to be provided. For example, a small ship having no satellite communication facility may be equipped with a system including a plurality of sensors 18, the network 13, the bridge-side computer 14, and the server 12 of the foregoing embodiment as a hull monitoring system.

Here, utilization of the data of the shape information of each member for each time described above in the hull structure digital twin system will be described.

A hull structure digital twin system is a digital twin system targeting a hull structure as an object and expected to improve the inconvenience that hull monitoring systems (HMS) in the related art often target only the integrity at the measurement point as an object and cannot evaluate the integrity in non-measurement location. In this hull structure digital twin system, as a part of the research and development thereof, application of an inverse finite element method (inverse FEM, iFEM) using strain field interpolation to hull structure monitoring is being examined. Specifically, strain measured at approximately dozens of measurement points using strain sensors is interpolated on the structure (hull) to obtain the overall strain field. Next, the displacement field of the entire hull is reconstructed using the iFEM with the strain field as an input. Moreover, the reconstructed displacement is given as a boundary condition for finite element analysis (FEA), allowing the stress generated under the estimated displacement to be reconstituted at an arbitrary place in the hull.

In this manner, in the hull structure digital twin system, a hull model created based on the design data is subjected to elementization (decomposed into a plurality of elements), and then displacement at each contact point is given as a boundary condition for the finite element analysis (FEA), allowing the stress generated under the foregoing displacement to be reconstituted at an arbitrary place in the hull.

Therefore, in the case of the present embodiment, it is expected to realize a hull structure digital twin system adopting an analysis technique in which there are as many points as possible such that displacement can be directly obtained from the shape information of each part of the hull obtained from the data received by the ship user's side computer (a computer capable of performing high-speed computation), elementization is performed so as to be consistent with the contact points after the elementization of the model, and stress generated under the foregoing displacement is reconstituted at an arbitrary place in the hull by applying the obtained displacement as the boundary condition for the finite element analysis (FEA). It is estimated that the value of the stress obtained in this case will be more accurate than when measured strain is interpolated on the structure, the overall strain field is obtained, the displacement field of the entire hull is reconstructed using the iFEM with the strain field thereof as an input, and then the displacement field is given as a boundary condition for the finite element analysis (FEA).

In the foregoing embodiment, a case in which identification information is input to each of the sensors 18 via the display operation unit 187 at the time of the initial settings of each of them has been described as an example. However, there is no particular restriction on the time, the method, and the like for inputting identification information to the sensors 18 (or storing it in the RAM (memory)). However, it is preferable for the sensor 18 used in the present embodiment to output data including an dentification code (ID) of the sensor 18.

The orthogonal polynomial described above which can be favorably used for function fitting to obtain the shape of one surface of a measurement target (object) is not limited to a Zernike polynomial and may be Fourier series, a Chebyshev polynomial, a Legendre polynomial, and others.

However, when a Zernike polynomial is used as a function expressing the shape of one surface of a measurement target (object), an in-plane distribution of the amount of deformation (amount of deviation) can be obtained utilizing component decomposition of the Zernike polynomial.

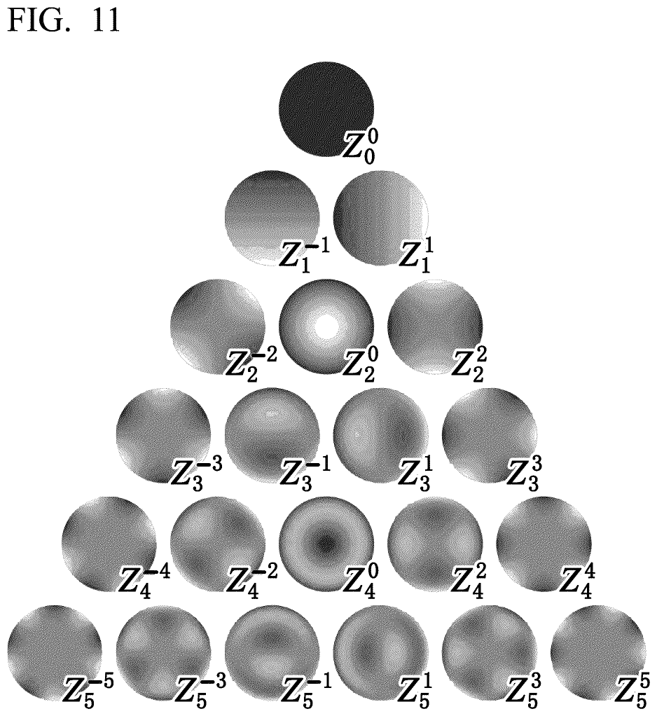

Here, component decomposition of a Zernike polynomial will be simply described. For ease of understanding, FIG. 11 shows the components of the first few terms in Zernike polynomial in Expression (1) as a shading pattern (the concentration at each coordinate point (ρ, θ) corresponds to the size (which can also be referred to as a deformation degree) in the z location at this point) within the unit circle of the polar coordinate system (ρ, θ). FIG. 11 shows a part of a map which is also referred to as a Zernike mode map.

The value of the determination coefficient kᵢ of each term in Expression (4) or Expression (9) described above shows the extent to which the component of each term is included. Moreover, the component diagram of FIG. 11 shows the deformation degree of each part within the circle. For example, when k₄, k₉, and k₁₆ are larger than others, it is ascertained that the components of Z₄, Z₉, and Z₁₆ having these as the coefficients are included more than others. Since the Fringe Zernike orders 4, 9, and 16 are respectively formed by arranging two indices (2, 0), (4, 0), and (6, 0) and integrating them into a single index, FIG. 11 provides an image in which the central part within the circle protrudes the most. However, Z₁₆ is not shown in FIG. 11. In the present embodiment, for example, a Zernike mode map from the first term to the 91st term for the Zernike polynomial is stored in the storage of the server 12. Therefore, the server 12 can numerically obtain, for example, the most protruding location (ρ, θ), and the amount of deformation (the amount of deviation from the reference surface), and the like based on the value of the coefficient kᵢ for each term and the Zernike mode map by decomposing the Zernike polynomial expressing the shape of one surface of the member (object), that is, the in-plane distribution of the amount of deformation for each component of each term. That is, in this manner, it is possible to analyze the amount of deformation on the measurement surface of a measurement target, that is, in the foregoing embodiment, a member constituting the hull (shell).

Therefore, for example, it is conceivable that information indicating a relationship between the proceeding direction of waves against the hull and the deformation state of the left and right side plates is obtained in advance by a simulation or a water tank test (which will be described below) using a model ship to estimate the proceeding direction of waves against the hull of the ship during navigation based on the information. In this case, it is conceivable that a map showing the distribution of the amount of deformation of the left and right side plates 34 obtained by the analysis of the amount of deformation using the Zernike mode map described above as the information of the deformation state is obtained in advance, and the map showing the distribution of the amount of deformation of the left and right side plates 34 during actual navigation of the ship is compared with the map obtained as the result of the analysis of the amount of deformation using the shape information of the left and right side plates 34 (expressed by the function of Expression (4) or Expression (9) described above) obtained based on the measurement results of the plurality of sensors to estimate the proceeding direction of waves against the hull from the comparison results.

The matter which has been described above regarding measurement of the shape of the hull during navigation of the ship can also be applied to ships during loading and unloading, during berthing, mooring, or the like against a rock wall.

In addition, in ship building, in order to check the speed of the ship desired by a shipowner, a required output of the engine, and the like, a model of the designed ship is made and tested in a water tank (water tank test). In this water tank test, as a premise thereof, it is important that the model is built in accordance with the design values. The method for measuring the shape of the shell constituent member described above can also be applied to shape measurement of this ship model.

In the foregoing embodiment, a case in which an object of monitoring a hull structure is a Handymax bulk carrier has been described as an example. However, the foregoing embodiment can also be favorably applied to bulk carriers having different sizes, specifically, bulk carriers of a small ship type, a handy-size ship type, a Panamax ship type, and a Capesize ship type.

In addition, the foregoing embodiment is not limited to bulk carriers and can be applied to all ships regardless of their intended use, including container ships and other cargo ships, merchant ships other than cargo ships (passenger ships, ferries, and the like), working ships (tugboats, dredgers, salvage vessels, and the like), fishing vessels (various fishing vessels, whaling ships, trawlers, and the like), special ships (submarine cable ships, weather observation vessels, deep sea research vessels, training ships, and the like), naval vessels (aircraft carriers, cruisers, escort ships, submarines, and the like), and the like. The foregoing embodiment can also be applied to newly built ships and ships currently in operation and has an advantage that the degree of freedom in disposition of the sensor devices is greater in newly built ships than in ships currently in operation.

### REFERENCE SIGNS LIST

10 Hull structure monitoring system
12 Server
13 Inboard network
14 Bridge-side computer
15 FBB terminal (ship communication facility)
18 Sensor device
32 Upper deck
46 Inner bottom plate (ship bottom member)
34 Ship-side shell plate
100 Ship
110 Hull

1. A hull structure monitoring system monitoring a shape of a hull of a ship, the system comprising:
a plurality of sensor devices and an analysis device connected to each other via an inboard network of a ship,
wherein each of the plurality of sensor devices targets some members constituting the hull as an object, measures tilt information of the object at each of a plurality of measurement points in different locations in one of two directions intersecting each other in the object, and outputs sensor data including the tilt information to the analysis device, and
the analysis device receives sensor data from the plurality of sensor devices and acquires shape information of the object as analysis results by performing analysis processing including predetermined computation processing using the sensor data.

2. The hull structure monitoring system according to claim 1,
wherein the object includes at least one of an upper deck, a ship bottom member, and side plates on port and starboard sides constituting a shell of the hull, sensor data output to the analysis device from the plurality of sensor devices includes tilt information related to at least one of the upper deck, the ship bottom member, and the side plates on the port and starboard sides, and the analysis device acquires shape information of the shell as the analysis results by performing the analysis processing using the sensor data received from the plurality of sensor devices.

3. The hull structure monitoring system according to claim 1, the system further comprising:
a bridge-side terminal connected to the inboard network,
wherein the analysis device supplies information of the analysis results to the bridge-side terminal via the inboard network.

4. The hull structure monitoring system according to claim 1,
wherein the object includes at least one of an upper deck, a ship bottom member, and side plates on port and starboard sides constituting a shell of the hull, and sensor data output to the analysis device from the plurality of sensor devices includes tilt information related to at least one of the upper deck, the ship bottom member, and the side plates on the port and starboard sides,
each of the plurality of sensor devices measures the tilt information and outputs the sensor data to the analysis device at a predetermined time interval, and
the analysis device receives the sensor data output from the plurality of sensor devices at the predetermined time interval for a certain period of time, and acquires shape information for each time related to at least one of the upper deck, the ship bottom member, and the side plates on the port and starboard sides as the analysis results by performing the analysis processing using the sensor data.

5. The hull structure monitoring system according to claim 4, the system further comprising:
a bridge-side terminal connected to the inboard network,
wherein the analysis device creates display data for displaying change over time in shape of the shell for the certain period of time from shape information for each time related to at least one of the upper deck, the ship bottom member, and the side plates on the port and starboard sides, and transmits the display data to the bridge-side terminal together with a display instruction command.

6. The hull structure monitoring system according to claim 5, the system further comprising:
a ship communication facility connected to the inboard network and performing data transmission between the analysis device connected to the inboard network and a ship user's side computer through communication,
wherein the analysis device supplies shape information for each time related to at least one of the upper deck, the ship bottom member, and the side plates on the port and starboard sides used in a process of creating display data for displaying change over time in shape of the hull for the certain period of time to the ship communication facility through the communication in order to transmit the shape information to the ship user's side computer.

7. The hull structure monitoring system according to claim 1,
wherein the analysis device obtains a discrete distribution of a physical quantity related to a tilt angle of the object based on the tilt information at measurement points in the object included in a plurality of pieces of sensor data output from a plurality of sensor devices targeting the same member as an object and corresponding locational information at respective measurement points, obtains a coefficient for each term of a predetermined polynomial function by fitting the distribution to the polynomial function, and acquires shape information of the object expressed by a polynomial function including the obtained coefficient as a determination coefficient for each term.

8. The hull structure monitoring system according to claim 7,
wherein the physical quantity is a gradient of a tangential plane on a measurement target surface of the object at each of the plurality of measurement points.

9. The hull structure monitoring system according to claim 7,
wherein a polynomial function used in the fitting is a function obtained by differentiating an orthogonal polynomial.

10. The hull structure monitoring system according to claim 9,
wherein a polynomial function used in the fitting is a differential Zernike polynomial obtained by differentiating a Zernike polynomial.

11. The hull structure monitoring system according to claim 9,
wherein a polynomial function including the obtained coefficient as a determination coefficient for each term is an orthogonal polynomial obtained by integrating a function obtained by the fitting.

12. The hull structure monitoring system according to claim 7,
wherein the physical quantity is an amount of deviation of a measurement target surface of the object with respect to a reference surface at each of the plurality of measurement points.

13. The hull structure monitoring system according to claim 12,
wherein a polynomial function used in the fitting is an orthogonal polynomial.

14. A method for monitoring change in shape of a hull of a ship, the monitoring method comprising:
measuring tilt information of a member constituting a shell of the hull at each of a plurality of measurement points in different locations in one of two directions intersecting each other in the member at a predetermined sampling interval using a plurality of sensors; and
acquiring information of change over time in shape of the member by performing predetermined computation processing using tilt information of the member at each of the plurality of measurement points measured at the predetermined sampling interval and corresponding locational information at the plurality of measurement points.

15. The monitoring method according to claim 14,
wherein in the measuring, tilt information of at least one member of an upper deck, a ship bottom member, and side plates on port and starboard sides constituting the shell at each of a plurality of measurement points in locations different from each other in the member is measured at a predetermined sampling interval using a plurality of sensors, and
in the acquiring, information of change over time in shape of the shell is acquired by performing predetermined computation processing using tilt information of at least one member of the upper deck, the ship bottom member, and the side plates on the port and starboard sides at a plurality of measurement points in the member measured using the plurality of sensors at the predetermined sampling interval and corresponding locational information at the plurality of measurement points.

16. The monitoring method according to claim 14,
wherein in the acquiring, a discrete distribution of a physical quantity related to a tilt angle of the measurement target member is obtained based on tilt information at each of measurement points in the member measured by a plurality of sensors targeting the same member as a measurement target and corresponding locational information at respective measurement points, a coefficient for each term of a predetermined polynomial function is obtained by fitting the distribution to the polynomial function, and shape information of the measurement target member expressed by a polynomial function including the obtained coefficient as a determination coefficient for each term is acquired.

17. The monitoring method according to claim 16,
wherein the physical quantity is a gradient of a tangential plane on a measurement target surface of the member at each of the plurality of measurement points.

18. The monitoring method according to claim 16,
wherein a polynomial function used in the fitting is a function obtained by differentiating an orthogonal polynomial.

19. The monitoring method according to claim 18,
wherein a polynomial function used in the fitting is a differential Zernike polynomial obtained by differentiating a Zernike polynomial.

20. The monitoring method according to claim 18,
wherein a polynomial function including the obtained coefficient as a determination coefficient for each term is an orthogonal polynomial obtained by integrating a function obtained by the fitting.

21. The monitoring method according to claim 16,
wherein the physical quantity is an amount of deviation of a measurement target surface of the member with respect to a reference surface at each of the plurality of measurement points.

22. The monitoring method according to claim 21,
wherein a polynomial function used in the fitting is an orthogonal polynomial.
